(19) United States
(12) Patent Application Publication
(10) Pub. No.: US 2024/0004954 A1
(43) Pub. Date: Jan. 4, 2024

(54) COMPUTER-IMPLEMENTED ACCUMULATION METHOD FOR SPARSE MATRIX MULTIPLICATION APPLICATIONS

(71) Applicant: Alibaba (China) Co., Ltd., Hangzhou (CN)

(72) Inventors: Zhaoyang DU, Hangzhou (CN); Yijin GUAN, Beijing (CN); Dimin NIU, Sunnyvale, CA (US); Hongzhong ZHENG, Los Gatos, CA (US)

(21) Appl. No.: 17/978,439

(22) Filed: Nov. 1, 2022

(30) Foreign Application Priority Data
Jul. 1, 2022 (CN) 202210775690.2

(51) Int. Cl. G06F 17/16; G06F 7/487; G06F 7/32

(52) U.S. Cl. CPC G06F 17/16; G06F 7/32; G06F 7/4876

(57) ABSTRACT

This application describes an hardware acceleration design for improving SpGEMM efficiency. An exemplary method may include: obtaining a first sparse matrix and a second sparse matrix for performing SpGEMM; allocating a pair of buffers respectively pointed by a first pointer and a second pointer; for each first row in the first sparse matrix that comprises a plurality of non-zero elements, identifying a plurality of second rows in the second sparse matrix that correspond to the plurality of non-zero elements; obtaining a plurality of intermediate lists computed based on each of the plurality of non-zero elements in the first row and one of the plurality of second rows that corresponds to the non-zero element; performing accumulation of the intermediate lists using the pair of buffers; and migrating the one final merged list to a system memory as a row of an output matrix of the SpGEMM.

### CROSS-REFERENCE TO RELATED APPLICATION

This application claims priority to and benefits of Chinese patent Application No. 202210775690.2, filed with the China National Intellectual Property Administration (CNIPA) on Jul. 1, 2022. The entire contents of the above-identified application are incorporated herein by reference.

### TECHNICAL FIELD

The disclosure relates generally to a memory-efficient accumulation method for sparse matrix multiplications.

### BACKGROUND

SpGEMM (General Sparse Matrix-Matrix Multiplication) has been a primitive and expensive computation kernel in numerous real-world applications, which involves performing SpGEMM on sparse matrices. For example, the publicly available SuiteSparse Matrix Collection is a large and actively growing set of sparse matrices that arises from a wide spectrum of domains, such as semiconductor devices, computer graphics and vision, robotics and kinematics, quantum chemistry, chemical process simulation, and so on.

While SpGEMM has been known as a memory-bounded algorithm, most of the existing work focuses on optimizing the computation throughput instead of memory efficiency. In fact, a more efficient memory design for SpGEMM may allow most of the data accessing and computing to be performed in cache, which would further improve the computation throughput. Therefore, a comprehensive performance model considering both computation throughput and memory overheads is highly desired.

### SUMMARY

Various embodiments of the present specification may include hardware circuits, systems, methods for efficient accumulation in SpGEMM applications.

According to one aspect, a computer-implemented method is described to implement memory-efficient accumulation in executing SpGEMM computations. The memory-efficient accumulation effectively reduces the memory consumption and maximizes memory reuse, which allows the memory-intensive intermediate products accumulation steps to be executed in low-latency memories. The method may start with obtaining, by a processor associated with a cache, a first sparse matrix and a second sparse matrix for performing SpGEMM; allocating, by the processor from the cache, a pair of buffers that are respectively pointed by a first pointer and a second pointer; for each first row in the first sparse matrix that comprises a plurality of non-zero elements, identifying, by the processor, a plurality of second rows in the second sparse matrix that correspond to the plurality of non-zero elements; obtaining, by the processor, a plurality of intermediate lists computed based on each of the plurality of non-zero elements in the first row and one of the plurality of second rows that corresponds to the non-zero element; storing, by the processor, the plurality of intermediate lists into the buffer pointed by the first pointer. At this point, the plurality of intermediate lists are ready to be merged into a final merged list, which will be used as a part of an output matrix of the SpGEMM. The merging process may be an iterative process, which includes: executing, by the processor, an iterative process comprising: merging the plurality of intermediate lists from the buffer pointed by the first pointer into a smaller number of intermediate lists; storing the smaller number of intermediate lists into the buffer pointed by the second pointer; swapping the first pointer and the second pointer; and determining whether an exit condition to exit the iterative process is met, wherein the exit condition comprises whether the smaller number of intermediate lists comprises one final merged list. After obtaining the one final merged list, the process may migrate it to system memory as an output.

In some embodiments, the method may further include: allocating an offset buffer comprising a plurality of offsets respectively corresponding to the plurality of intermediate lists, wherein each offset points to a first unmerged element in the corresponding intermediate list.

In some embodiments, the method may further include: in response to merging the plurality of intermediate lists into the smaller number of intermediate lists, updating the offset buffer so that each index points to an offset of a first unmerged element in one of the smaller number of intermediate lists.

In some embodiments, the merging the plurality of intermediate lists from the buffer pointed by the first pointer into the smaller number of intermediate lists and storing the smaller number of intermediate lists into the buffer pointed by the second pointer comprises: for two adjacent intermediate lists of the plurality of intermediate lists: (1) determining two memory offsets in the buffer pointed by the first pointer, the two memory offsets pointing to the two intermediate lists respectively; (2) determining a destination memory offset in the buffer pointed by the second pointer; (3) retrieving, at the memory offsets of the buffer pointed by the first pointer, column indices of two elements; (4) in response to the column indices of the two elements being same, aggregating values of the two unmerged elements to obtain an aggregated value, storing the aggregated value into a merged list starting at the destination memory offset in the buffer pointed by the second pointer; (5) in response to the column indices of the two elements being different, storing one of the two unmerged elements that comprises a smaller value into the merged list starting at the destination memory offset in the buffer pointed by the second pointer; and repeating steps (1)-(5) until the two intermediate lists are merged into the merged list in the buffer pointed by the second pointer.

In some embodiments, the first sparse matrix and the second sparse matrix are stored in a compact data format, wherein the compact data format excludes zero-value data in the first sparse matrix and the second sparse matrix.

In some embodiments, the method may further include determining a buffer size for the pair of buffers by performing a symbolic computation based on indices of non-zero elements in the first sparse matrix and row sizes of the second sparse matrix, wherein the symbolic computation estimates a maximum number of floating-point multiplication operations (FLOP) in a hypothetical multiplication between each of the plurality of first rows and the second sparse matrix, wherein the allocating the pair of buffers comprises: allocating each of the pair of buffers with the buffer size.

In some embodiments, the symbolic computation may be performed by: for each of the plurality of first rows that comprises one or more non-zero elements, identifying one or more corresponding second rows from the second sparse matrix; determining a number of FLOP for the each first row based on a number of non-zero elements in the one or more corresponding second rows from the second sparse matrix; and determining the maximum number of FLOP of the plurality of first rows as the buffer size.

In some embodiments, the processor may include a multi-core processor, and the method further comprises: segmenting rows of the first sparse matrix into multiple groups of first rows according to a number of cores in the multi-core processor; and assigning the multiple groups of first rows into the number of cores for parallel processing, wherein each core allocates a corresponding pair of buffers.

In some embodiments, the multi-core processor may include a multi-core CPU, or a GPU, and the number of cores comprise a plurality of Streaming Multiprocessors (SMs) of the GPU.

In some embodiments, the offset buffer comprises a pair of index lists respectively corresponding to the pair of buffers.

In some embodiments, the method may further include determining a buffer size for the offset buffer based on a maximum number of non-zero data in each row of the first sparse matrix.

According to another aspect, a system for memory-efficient accumulation to accelerate SpGEMM computations is described. The system may include one or more processors and one or more non-transitory computer-readable memories coupled to the one or more processors and configured with instructions executable by the one or more processors to cause the system to perform operations including: obtaining a first sparse matrix and a second sparse matrix for performing SpGEMM; allocating a pair of buffers respectively pointed by a first pointer and a second pointer; for each first row in the first sparse matrix that comprises a plurality of non-zero elements, identifying a plurality of second rows in the second sparse matrix that correspond to the plurality of non-zero elements; obtaining a plurality of intermediate lists computed based on each of the plurality of non-zero elements in the first row and one of the plurality of second rows that corresponds to the non-zero element; storing the plurality of intermediate lists into the buffer pointed by the first pointer; executing an iterative process comprising: merging the plurality of intermediate lists from the buffer pointed by the first pointer into a smaller number of intermediate lists; storing the smaller number of intermediate lists into the buffer pointed by the second pointer; swapping the first pointer and the second pointer; and determining whether an exit condition to exit the iterative process is met, wherein the exit condition comprises whether the smaller number of intermediate lists comprises one final merged list; and migrating the one final merged list to a system memory as a row of an output matrix of the SpGEMM.

According to yet another aspect, a non-transitory computer-readable storage medium for memory-efficient accumulation to accelerate SpGEMM computations is described. The non-transitory computer-readable storage medium stores instructions that, when executed by one or more processors, may cause the processors to perform operations including: obtaining a first sparse matrix and a second sparse matrix for performing SpGEMM; allocating a pair of buffers respectively pointed by a first pointer and a second pointer; for each first row in the first sparse matrix that comprises a plurality of non-zero elements, identifying a plurality of second rows in the second sparse matrix that correspond to the plurality of non-zero elements; obtaining a plurality of intermediate lists computed based on each of the plurality of non-zero elements in the first row and one of the plurality of second rows that corresponds to the non-zero element; storing the plurality of intermediate lists into the buffer pointed by the first pointer; executing an iterative process comprising: merging the plurality of intermediate lists from the buffer pointed by the first pointer into a smaller number of intermediate lists; storing the smaller number of intermediate lists into the buffer pointed by the second pointer; swapping the first pointer and the second pointer; and determining whether an exit condition to exit the iterative process is met, wherein the exit condition comprises whether the smaller number of intermediate lists comprises one final merged list; and migrating the one final merged list to a system memory as a row of an output matrix of the SpGEMM.

These and other features of the systems, methods, and hardware devices disclosed, and the methods of operation and functions of the related elements of structure and the combination of parts and economies of manufacture will become more apparent upon consideration of the following description and the appended claims referring to the drawings, which form a part of this specification, where like reference numerals designate corresponding parts in the figures. It is to be understood, however, that the drawings are for illustration and description only and are not intended as a definition of the limits of the invention.

### BRIEF DESCRIPTION OF THE DRAWINGS

FIG. 1 illustrates a schematic diagram of a hardware environment for implementing memory-efficient accumulation for SpGEMM (General Sparse matrix-matrix Multiplication) in accordance with some embodiments.

FIG. 2 illustrates a row-based approach for executing SpGEMM with efficient memory allocation in accordance with some embodiments.

FIG. 3 illustrates an exemplary block diagram of a multi-core processor with distributed memory-efficient accumulation for SpGEMM in accordance with some embodiments.

FIG. 4 illustrates exemplary memory layouts and a workflow for performing memory-efficient accumulation for SpGEMM in accordance with some embodiments.

FIG. 5 illustrates an exemplary method for performing memory-efficient accumulation for SpGEMM in accordance with some embodiments.

FIG. 6 illustrates an exemplary method of memory-efficient accumulation for SpGEMM in accordance with some embodiments.

FIG. 7 illustrates a block diagram of a hardware device with memory-efficient accumulation for SpGEMM in accordance with some embodiments.

### DETAILED DESCRIPTION

The specification is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present specification. Thus, the specification is not limited to the embodiments shown but is to be accorded the widest scope consistent with the principles and features disclosed herein.

In sparse matrices, typically, the number of non-zero (NNZ) elements is much smaller than the number of zero elements. When storing sparse matrices in computer systems, compact data structures are often used to save the memory footprint of the matrices. These data structures may include Coordinate list (COO), Compressed Sparse Row (CSR), bit map, etc. General sparse matrix-matrix multiplication (SpGEMM), involving multiplying two sparse matrices, is a fundamental and expensive computational kernel in numerous scientific computing applications and graph algorithms, such as algebraic multigrid solvers, triangle counting, multi-source breadth-first searching, and so on.

SpGEMM is notoriously hard to optimize for its essential irregular properties. To name a few, it has an irregular access pattern to the memory system, and computation irregularity that leads to load imbalance for multi-threaded design. In this disclosure, algorithm optimizations are provided for SpGEMM on modern many-core CPU architectures, since 1) CPU platforms are widely available for more researchers and institutes, 2) applications containing SpGEMM kernel are more flexibly developed on CPU platforms, making CPU the most widely used platforms for such irregular applications, and 3) it is observed that previous SpGEMM algorithms fail to achieve the optimal algorithm design on CPUs. However, memory-efficient accumulation methods disclosed herein may also be applicable to other processor architectures like GPUs provided with proper memory configuration. A person skilled in the art would appreciate the architectural differences and make the described method platform-agnostic.

For easy understanding, several terms used in the following description are defined here, unless otherwise specified.

Capital letters A, B, and C denote matrices. A and B are input matrices. The size of A and B are (M,K) and (K,N), respectively. C is the result matrix of dimension (M*N). “aᵢⱼ” denotes a non-zero element in the iₜₕ row and jₜₕ column of A. “a_{i*}” denotes all the non-zero elements in the iₜₕ row of A.
“nnz(c_{i*})” denotes the number of non-zero elements in the iₜₕ row of C.
“flop(c_{i*})” denotes the number of multiplications involved in computing the iₜₕ row of C.

FLOP refers to the number of floating-point multiplication operations to compute an output matrix or a row of the output matrix. In this disclosure, floating-point multiplication is used as an example. In some embodiments, the multiplication operations may be based on integers.

FLOPR refers to the number of floating-point multiplication operations to compute a row of the output matrix.

NNZ refers to the number of non-zero elements of a matrix or a row of a matrix.

NNZR refers to the number of non-zero elements of a row of a matrix.

Compression Ratio (CR) refers to FLOP/NNZ of the output matrix or a row of the output matrix.

Due to the flexibility of matrix multiplication and irregularity of sparse matrix storage format, SpGEMM may adopt a very wide range of different computation routines. On a high level, SpGEMM algorithms are well classified into four categories: inner-product SpGEMM, outer-product SpGEMM, row-wise SpGEMM, and column-wise SpGEMM.

In inner-product SpGEMM, one atomic task is defined as the inner product of the iₜₕ row of A and jₜₕ column of B to obtain one element cᵢⱼ in C. This scheme can require the multiplication of two sparse vectors, which is inefficient because of many non-effect data accesses with zero elements. Moreover, the multiplication results of the two sparse vectors are most likely zeros, which contribute nothing to the output matrix in a sparse storage format. Therefore, this scheme is not feasible on the theoretical level due to extreme inefficiency.

In outer-product SpGEMM, the first atomic task is defined as the outer product of the iₜₕ column of A and the iₜₕ row of B to obtain a total partial result matrix. In this task, there will be K partial result matrices. The second atomic task is to merge the K partial result matrices row-by-row to get the result matrix. To complete the second atomic task, it is required to allocate memory space for all the intermediate partial matrices or write each partial matrix to the result buffer with hash data structure on the fly. Under high-performance settings, multi-threaded operations are the norm. Therefore, the huge memory footprint or the concurrent write can be a performance restriction for outer product SpGEMM.

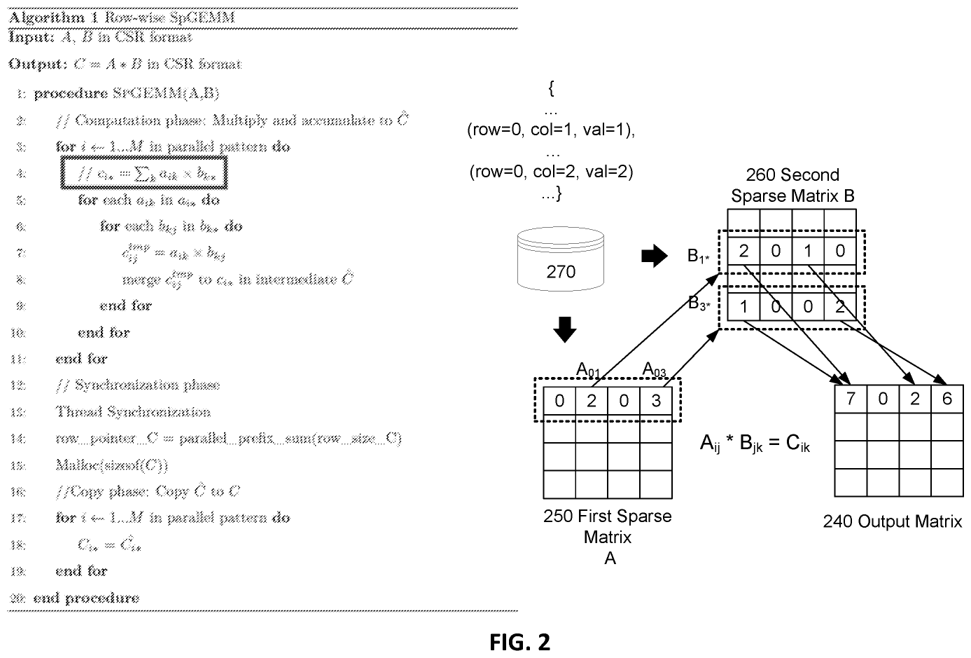

In row-wise SpGEMM, the atomic task is defined as the multiplication and accumulation of iₜₕ row of A with corresponding rows of B to obtain the iₜₕ row of C. It is naturally easy to be parallelized on the single-row granularity without concurrent write issues. Moreover, it has the flexibility to adopt multiple allocation methods for handling the intermediate result matrix. More details about row-wise SpGEMM may refer to FIG. 2 and corresponding descriptions.

The computation procedure and memory access pattern of column-wise SpGEMM is dual of row-wise SpGEMM. Thus a row-wise SpGEMM algorithm can be easily transformed to a column-wise SpGEMM algorithm with the theoretical same performance. The following description focuses on the row-wise SpGEMM algorithm design for brevity.

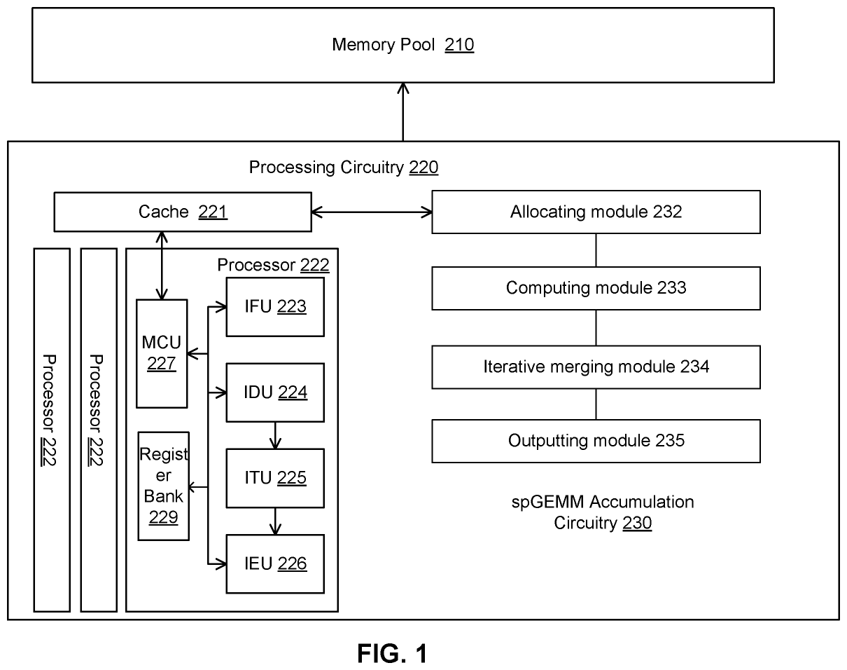

FIG. 1 illustrates a schematic diagram of a hardware environment for implementing memory-efficient accumulation for SpGEMM (General Sparse matrix-matrix Multiplication) in accordance with some embodiments.

As shown, the hardware environment in FIG. 1 includes a memory pool 210, a processing circuitry 220, and a SpGEMM accumulation circuitry 230. The layout of the components in the hardware environment is for illustrative purposes, and may be implemented in different ways depending on the actual hardware configuration. In some embodiments, the SpGEMM accumulation circuitry 230 may be implemented as a standalone hardware accelerator that is separated from the processing circuitry 220 (e.g., one or more CPUs or GPUs). In some embodiments, the SpGEMM accumulation circuitry 230 may be implemented as a part of the processing circuitry 220 (e.g., a part of one or more CPUs or GPUs) to improve the efficiency of memory management. The memory pool 210 may refer to external storage devices, system RAM, other types of memory resources, or any combination thereof.

In some embodiments, the processing circuitry 220 may include one or more processors 222 and a cache 221 shared by the one or more processors 222. Each processor 222 may include an instruction fetching unit (IFU) 223, an instruction decoding unit (IDU) 224, an instruction transmitting unit (ITU) 225, and an instruction execution unit (IEU) 226.

In some embodiments, the IFU 223 may fetch to-be-executed instructions or data from the storage/memory 210 to a register bank 229. In some embodiments, the to-be-executed instructions or data can be fetched into the cache 221 and sent to the IFU 223 via microcontroller unit (MCU) 227. After obtaining the instructions or data, the scheduler 220 enters an instruction decoding stage. The IDU 224 decodes the obtained instruction according to a predetermined instruction format to determine operand(s) acquisition information, where the operands are required to execute the obtained instruction. In some embodiments, the operand(s) acquisition information may include pointers or addresses of immediate data, registers, or other software/hardware that provide the operand(s).

In some embodiments, the ITU 225 may be configured to receive the decoded instructions from the IDU 224 and perform instruction scheduling and management. It may efficiently allocate instructions to different IEUs 226 for parallel processing. In some embodiments, after the ITU 225 allocates an instruction to one IEU 226, the IEU 226 may execute the instruction.

In some embodiments, the SpGEMM accumulation circuitry 230 may receive instructions from processing unit 220, access data from the memory pool 210, and perform accumulation of intermediate products to generate a row of an output matrix of SpGEMM. The SpGEMM accumulation circuitry 230 may send the row of an output matrix back to the processing unit 220 for aggregation.

In some embodiments, the SpGEMM accumulation circuitry 230 may include a microprocessor for executing instructions to determine buffer sizes, request/allocate buffers according to the determined sizes, compute intermediate products, perform accumulation of the intermediate products using the buffers to generate outputs of the SpGEMM, etc. In some embodiments, the SpGEMM accumulation circuitry 230 may include an allocating module 232, a computing module 233, an iterative merging module 234, and an outputting module 235. In some embodiments, before triggering SpGEMM accumulation circuitry 230, a first sparse matrix and a second sparse matrix for performing SpGEMM may be loaded and stored in the memory pool 210 in a compact data format. The compact data format may exclude zero-value data in the first sparse matrix and the second sparse matrix and only store information (index information and value information) of non-zero data. The SpGEMM operations to be performed between the first sparse matrix and the second sparse matrix may be distributed into the plurality of processors 222 in the processing circuitry 220 for parallel processing. Each processor 222 may handle the computations between a subset of rows of the first sparse matrix and the second sparse matrix, and generate values for a subset of rows in the output matrix of the SpGEMM. Here, the computations refer to row-wise matrix multiplications for illustrative purposes. The following description uses one processor 222 as an example to demonstrate the workflow of the SpGEMM accumulation circuitry 230.

In some embodiments, the allocating module 232 may be configured to determine an upper bound buffer size for storing intermediate products, and allocate a pair of buffers from the memory system. Each of the buffers has a size of the upper-bound buffer size. The pair of buffers are respectively pointed by a first pointer and a second pointer. This pair of buffers may be referred to as ping-pong buffers for performing memory-efficient accumulation of the intermediate products. For example, the multiplication of a first row from the first sparse matrix with corresponding rows in the second sparse matrix may generate an output row for the output matrix of the SpGEMM. During this process, lists of intermediate products may be generated and accumulated to generate the output row.

In some embodiments, the computing module 233 may be configured to implement the multiplications between the first row from the first sparse matrix and the corresponding rows in the second sparse matrix to generate the lists of intermediate products. For example, based on row-wise matrix multiplications, the multiplication between the first row and the corresponding rows may include: obtaining column indices of non-zero data in the first row; identifying a plurality of corresponding rows in the second sparse matrix based on the column indices of the non-zero data in the first row; multiplying each non-zero data in the first row with the non-zero data in the corresponding row from the second sparse matrix to obtain a list of intermediate products. That is, each non-zero data in the first row will generate a list of intermediate products. In some embodiments, all non-zero data in the first row may be sequentially processed to generate a plurality of lists of intermediate products. These lists of intermediate products may be sequentially stored into a first buffer of the pair of buffers (e.g., the buffer being pointed by the first pointer) in preparation for accumulation.

In some embodiments, the iterative merging module 234 may be configured to iteratively merge the plurality of lists of intermediate products into one list of products using the ping-pong buffers. The merge may be a necessary step to obtain the output row because some of the intermediate products may contribute to the same output value (e.g., these intermediate products may be referred to as partial products, which need to be aggregated to generate a final product in the output row). In some embodiments, this merge process may include: merging the plurality of intermediate lists from the buffer pointed by the first pointer into a smaller number of intermediate lists; storing the smaller number of intermediate lists into the buffer pointed by the second pointer; swapping the first pointer and the second pointer; and determining whether an exit condition to exit the iterative process is met, wherein the exit condition comprises whether the smaller number of intermediate lists comprises one final merged list. For example, the one final list indicates that the smaller number of intermediate lists has been merged iteratively so that only one merged list becomes the final result.

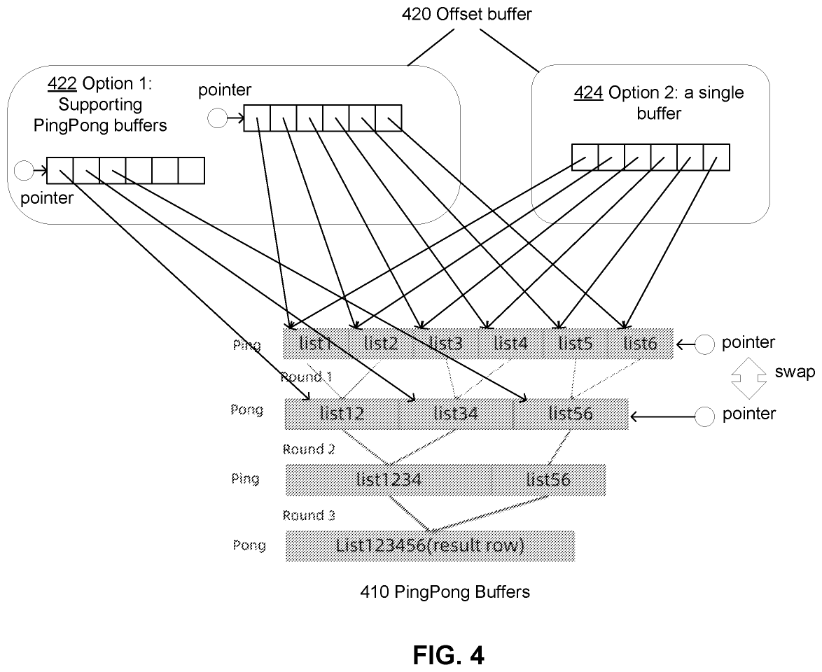

In some embodiments, every two adjacent intermediate lists may be merged into one new list. The merging process of the two adjacent intermediate lists may include: (1) determining two memory offsets, referred to as source offsets, in the buffer pointed by the first pointer, where the two memory offsets point to the start of two unmerged lists in the two adjacent intermediate lists respectively; (2) determining a memory offset, referred to as destination offset, in the buffer pointed by the second pointer; (3) retrieving, at the two source memory offsets of the two unmerged lists, column indices of the two unmerged elements; (4) in response to the column indices of the two unmerged elements being same, aggregating values of the two unmerged elements to obtain an aggregated value, storing the aggregated value into a merged list in the buffer pointed by the second pointer at the destination offset, increasing the two source memory offsets by 1, and increasing the destination offset by 1; (5) in response to the column indices of the two unmerged elements being different, storing one of the two unmerged elements that comprises a smaller column index into the merged list in the buffer pointed by the second pointer at the destination offset, increasing the source memory offset with a smaller column index by 1, and increasing the destination offset by 1; and (6) repeating steps (1)-(5) until the two intermediate lists are merged into the merged list in the buffer pointed by the second pointer. That is, the elements in the two adjacent intermediate lists stored in the first buffer are sequentially merged, deduplicated, and copied to the other buffer. Among these steps, it may be noted that the aggregated value is stored along with its index information into the merged list in the buffer pointed by the second pointer. The index information may include the column index representing a location within the output matrix. In some embodiments, an additional buffer may be created to monitor the memory offsets corresponding to the next to-be-merged (unmerged) elements in each of the to-be-merged lists (e.g., the intermediate lists). This additional buffer may include one buffer or another set of ping-pong buffers. More details may refer to, for example, FIG. 4. When all the intermediate lists has been merged two-by-two in the buffer pointed by the first pointer to the buffer pointed by the second pointer, one round of merge is done.

After one round of merge, the plurality of intermediate lists stored in the first buffer are merged into a smaller number of merged lists in the other buffer. For example, the “smaller number” may be half of the number of the plurality of intermediate lists. The merge may go on for multiple rounds until only one merged list is generated (e.g., all the partial products in the intermediate lists are merged).

In order to re-use the ping-pong buffers across multiple rounds of merging without consuming new memory resources, the pointers pointing to the ping-pong buffers may be swapped. The swapping of the pointers may switch the roles of the two buffers without moving the data around. The buffer storing the merged lists in the previous round of merge now becomes the buffer storing the to-be-merged lists, and the buffer previously stores the original intermediate lists now becomes the target buffer to receive the newly merged lists, with its original data safely discarded. This swapping step allows efficient reuse of the algorithm logic and the corresponding instruction without expensive data migration cost. This iterative merging process may continue until one final merged list is generated.

In some embodiments, the outputting module 235 may migrate the one final merged list from the cache 221 of the processing circuitry 220 to the memory pool (e.g., one or more non-transitory memories) as one row in the output matrix of the SpGEMM. The cache 221 refers to an on-chip cache that is closer to the processors 222 and has a faster data access rate than the memory pool 210. As shown, even though the input matrices are generally too large to fit in the on-chip cache 221, the partial products generated based on a few rows of the input matrices may be kept in the cache 221. This way, the most computation-intensive step of the SpGEMM, i.e., merging partial products into final products, may be performed as in-cache operations without external memory access. Accordingly, the overall efficiency of the SpGEMM is significantly improved. In addition, since the ping-pong buffers are highly re-useable, the memory footprint for merging the partial products is minimized.

FIG. 2 illustrates an exemplary row-based approach for executing SpGEMM with efficient memory allocation in accordance with some embodiments. In some embodiments, the SpGEMM accumulation circuitry 230 in FIG. 1 relies on row-based matrix multiplications.

As shown in FIG. 2, the SpGEMM involves two sparse input matrices 250 and 260. These sparse matrices may be stored in a data repository 270 (e.g., a database, a cloud server) in a compact storage format, such as COO, CSR, bit maps, etc. These compact storage formats may only store the non-zero elements in the sparse matrices (along with their index information) to save storage space and facilitate access to non-zero elements. In some practical applications, the non-zero elements generated as part of the SpGEMM using row-based matrix multiplication may include a plurality of duplicated data entries. The term “duplicated data entries” refers to multiple values corresponding to the same row index and column index (also called a row-column index pair) in the output matrix and need to be aggregated to generate one output value.

In some embodiments, while reading the non-zero elements from the data repository 270, an iterative process of row-based matrix multiplication may be performed. For example, the first row (row=0) of the first sparse matrix A 250 in FIG. 2 may include multiple non-zero elements (e.g., Aₒ₁ and A₀₃ at column 1 and 3, respectively). For each of these non-zero elements, a corresponding row of the second sparse matrix B 260 may be obtained. The corresponding row from B may have a row index equal to the column index of the non-zero element. For instance, Aₒ₁ corresponds to row B_{1*} of matrix B. The non-zero element from matrix A then may multiply with all non-zero elements in the corresponding row from B. For each multiplication between the element at (row=i, col=j) of matrix A and the element at (row=j, col=k) of matrix B, the resulting output value may be placed at a position (row=i, col=k) of an output matrix 240. This principle may be denoted as Aᵢⱼ*Bⱼₖ=Cᵢₖ. After processing all of the non-zero elements in the first row of matrix A, the next row of matrix A may be processed. In some embodiments, since the rows of the matrix A in the row-based matrix multiplication may be processed independently, parallel processing techniques may be applied to improve the computation efficiency. In some embodiments, when multiple processes are writing multiplication results into the same cell in the output matrix 240, these writes may be synchronized using locking mechanisms.

With the above description, the difference between a textbook row-column matrix multiplication and the row-based matrix multiplication becomes obvious. In the textbook row-column matrix multiplication, a row from a first matrix is multiplied with a corresponding column from a second matrix, and the multiplication results may be summed up to generate one output value in an output matrix. That is, in the textbook row-column matrix multiplication, each multiplication operation in one execution cycle will generate one final output value for the output matrix. In contrast, row-based approach involves multiplying a first row from the first matrix and a plurality of corresponding second rows from the second matrix in a plurality of execution cycles. Each multiplication between the first row and each second row may generate one or more partial output values for a row of the output matrix. These partial output values generated from the plurality of multiplications during the plurality of execution cycles may be aggregated to generate the final output values for the row of the output value.

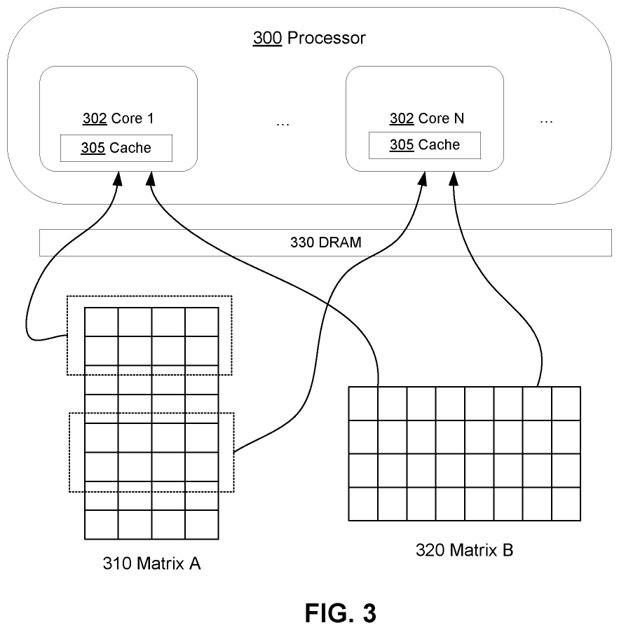

FIG. 3 illustrates an exemplary block diagram of a multi-core processor 300 with distributed memory-efficient accumulation for SpGEMM in accordance with some embodiments. The multi-core processor 300 may be, for example, a multi-core CPU, or a GPU with a plurality of Streaming Multiprocessors (SMs). Depending on the architecture of the multi-core processor 300, the cache 305 may be an on-chip cache that is shared by the multiple cores or a non-shared cache for each core.

As shown in FIG. 3, a matrix A 310 and a matrix B 320 involved in SpGEMM may need to be multiplied to generate an output matrix. These matrices A 310 and B 320 may be loaded into a DRAM 330 from an external storage. In order to improve the efficiency of SpGEMM, the computations may be distributed among the cores 302 by taking advantage of the fact that the row-wise SpGEMM computations generate rows of outputs independently. For example, in row-wise matrix multiplication, each row from the matrix A 310 may be multiplied with corresponding rows from the matrix B 320 to generate one output row for the output matrix. Therefore, the rows of the matrix A 310 may be distributed and assigned to the plurality of cores 302 for parallel processing. It is possible that two cores may need to read the same row of the matrix B 320 to perform their respective computations. However, these read operations do not update the matrix B 320 or cause data conflicts, thus can be performed simultaneously (e.g., no locking or synchronization or cache-coherency issue is involved).

FIG. 4 illustrates exemplary memory layouts and a workflow for performing memory-efficient accumulation for SpGEMM in accordance with some embodiments. The memory layouts and the workflow in FIG. 4 are for illustrative purposes. As shown in FIG. 4, the memory layout includes a set of ping-pong buffers 410, and an offset buffer 420. The ping-pong buffers 410 may refer to the main memory spaces used for merging intermediate lists (in which the intermediate products are stored). The offset buffer 420 may refer to an additional buffer storing pointers or memory offsets that point to the next merged and to-be-merged elements in each of the intermediate lists in the ping-pong buffers 410.

In describing the buffer designs in FIG. 4, it is assumed that there are six to-be-merged intermediate lists, denoted as “list 1 to list 6.” That is, in SpGEMM between two input matrices, one first row in the first input matrix includes six non-zero data, and each non-zero data corresponds to one second row in the second input matrix. Here, the “correspondence” may be defined as: for each non-zero data in the first row, the row index of the corresponding second row is the same as the column index of the each non-zero data in the first row. The product of each non-zero data with the corresponding second row may generate one intermediate list. Thus, with six non-zero data in the first row, six intermediate lists may be generated. These six intermediate lists, referred to as partial products, contain intermediate products that contributes to the same output row in the output matrix of the SpGEMM. Therefore, the six intermediate lists need to be merged into a final list by aggregating/accumulating these partial products. In some embodiments, one processing unit (e.g., a core in a multi-core CPU) handles the entire first row, and may sequentially process all the non-zero data therein and thus generate the intermediate lists sequentially.

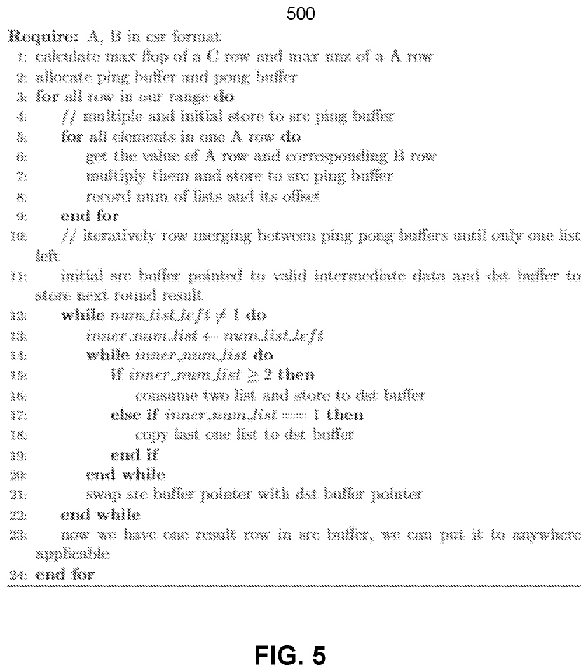

In some embodiments, before starting the process to merge the intermediate lists, the processor may determine the buffer size of the ping-pong buffers 410 for allocation. In some embodiments, the ping-pong buffers 410 may include a source buffer and a destination buffer, where the source buffer stores the to-be-merged intermediate lists for the current merging round, and the destination buffer stores the merged lists generated during the current merging round. In some embodiments, the source buffer and the destination buffer may be allocated with the same memory size. Because the source buffer may be initialized (for the first round of merging) to store the intermediate lists (i.e., all the intermediate products) directly generated based on the multiplications between the non-zero data from the first row and the corresponding rows, the memory size of the two ping-pong buffers may be determined by the max or upper-bound FLOP to compute each result row. The FLOP may be determined by performing a symbolic computation based on the index information of the non-zero data in the first matrix and the row sizes of the rows in the second matrix. Here, the “row size” of a row refers to the number of non-zero data in the row. More details about the buffer size determination may refer to FIG. 5.

Referring back to FIG. 4, during merge round 1, every two consecutive intermediate lists from the source buffer may be merged into one list and stored into the destination buffer. For example, list 1 and list 2 may be merged into list 12. The merging of two consecutive lists may use two running entries (e.g., two pointers) to traverse the two lists. Values with the same column indices may be added together and copied into the destination buffer, while values with different column indices may be directly copied into the destination buffer. Note that this merging method requires the initial intermediate lists are all sorted based on column indices, which is natively guaranteed when the input matrix is stored in the standard CSR format. The merged list generated based on two sorted lists is natively sorted.

In some embodiments, the source buffer and destination buffer are reused across different merging rounds. In some embodiments, the source buffer in the previous merging round becomes the destination buffer in the next merging round, and the destination buffer in the previous merging round becomes the source buffer in the next merging round. This may be achieved by swapping the pointers pointing to the two buffers, where the pointers serve as references to the buffers (the processor uses the pointers to find the corresponding buffers). This pointer-swapping method effectively avoids data migration between the ping-pong buffers 410, which improves the merging efficiency. The ping-pong buffers 410 in FIG. 4 are used in three rounds of merging, and the six lists are eventually merged into one list list123456. It may be noted that the different buffers (four illustrated buffers in 410) used across different rounds of merging in FIG. 4 are the logic view only, and they are actually implemented using only two physical ping-pong buffers by swapping the pointers.

At the beginning of each merging round, the processor may look for the starting point of each to-be-merged list in the source buffer and sequentially iterate through them for merging. The starting points may be represented as memory offsets. In some embodiments, two offset buffer 420 may be created to keep track of the memory offsets of the to-be-merged lists in the source buffer and the merged lists in the destination buffer. There are different options to implement this offset buffer 420. As shown in FIG. 4, option 1 includes creating another set of offset ping-pong buffers 422 respectively monitoring the offsets of the main set of ping-pong buffers 410. The size of each buffer in the offset ping-pong buffers 422 may be determined as the maximum number of to-be-merged lists, i.e. the maximum number of row size of the A matrix. The “row size” of a row refers to the number of non-zero data in the row.

In some embodiments, the memory footprint of the offset buffer 420 may be further reduced as shown in option 2 in FIG. 4. Instead of creating a pair of offset buffers 422, only one buffer 424 is created to keep track of the offsets of the lists in both the source buffer and the destination buffer of the two ping-pong buffers 410. At beginning of a merging round, this one buffer 420 may include a plurality of slots, each slot storing the offsets of the to-be-merged intermediate lists. The processor reads the first two slots from the single buffer 424 to determine the memory offsets of the first two intermediate lists in the source buffer of the ping-pong buffers 410. These two intermediate lists may then be merged into one merged list in the destination buffer. The single buffer 424 may then store the offset of the merged list in the destination buffer in its first slot. Similarly, after the third and fourth intermediate lists from the source buffer are merged into the second merged list, the memory offset of the second merged list may be stored in the second slots of the single buffer 424. This way, the single buffer 424 is updated in a rolling fashion: after two slots are read by the processor, these two slots may be freed and reused to store the offset of the newly generated list. Since the merging process always reads more lists and generates fewer new lists (e.g., reading two lists and generating one list), it is guaranteed that the slot for storing the memory offset of the newly generated list has been read and freed. Thus, this rolling update of the single buffer 424 may effectively re-use the memory slots and further improve memory efficiency.

FIG. 5 illustrates an exemplary method 500 for performing memory-efficient accumulation for SpGEMM in accordance with some embodiments. The method 500 may be executed by a processor (a CPU, a core of a multi-core CPU, a GPU, or a processor within a GPU) to perform SpGEMM computation between matrix A and matrix B. According to method 500, the processor may receive inputs including index information of matrix A and matrix B, perform symbolic computations based on the index information of matrix A and matrix B to determine one or more buffer sizes, allocate a ping-pong buffer and an offset buffer based on the determined buffer sizes, read the floating numbers (from those rows assigned to the processor for processing) of matrix A and matrix B, conduct floating number computations to generate lists of intermediate products, store the lists into the ping-pong buffer, conduct iterative merging of these lists using the ping-pong buffer with the help of the offset buffer, and eventually generate a final row of output values for the SpGEMM.

As shown in FIG. 5, method 500 includes two phases: multiply phase and merge phase. In the multiply phrase, at, is multiplied with the corresponding rows of B to obtain multiple intermediate lists. The intermediate lists are consecutively stored in one of the ping-pong buffers. In the merge phase, the nnz(a_{i*}) intermediate lists are merged in a manner similar to merge sort. Two consecutive lists will be merged to one list then the merged list is stored to another ping-pong buffer with recorded offset.

In addition to the multiply phase and merge phase, the processor may also determine the buffer size for the ping-pong buffer. In some embodiments, the buffer size may be determined by performing a symbolic computation based on indices of non-zero data in matrix A and row sizes of the matrix B. The symbolic computation estimates a maximum number of floating-point multiplication operations (FLOP) in a hypothetical multiplication between each row of matrix A and the corresponding rows in matrix B. The symbolic computation avoids reading and computing the actual floating numbers, which saves computing resources such as processing cycles. In some embodiments, the symbolic computation may include: for each of the plurality of first rows in matrix A that comprises one or more non-zero elements, identifying one or more corresponding second rows from matrix B; determining a number of floating-point multiplication operations for the each non-zero element of the first row as the number of non-zero elements of the corresponding row of the second matrix; summing up all the number of floating-point multiplication operations for the each non-zero element of the first row as the FLOP required to compute the corresponding row of the result matrix; and determining the maximum FLOP of the plurality of the result rows as the buffer size.

The previous description explains the technical advantages of the memory-efficient accumulation method by using ping-pong buffers. The following section further quantifies these technical advantages by comparing the described method against several exemplary existing solutions from the perspectives of memory efficiency and computation efficiency.

Existing works tackling intermediate products accumulation in SpGEMM include heap-based SpGEMM and hash-based SpGEMM.

Heap-based SpGEMM uses a heap data structure of length k(k=nnz(a_{i*})) to contain the k running entries of k intermediate row lists. Then it merges the k partial row lists to the result row with naturally sorted attribution. Heap-based SpGEMM's main memory access and computation are uniformly interleaved, which is not friendly for cache-line maintaining and main memory's active row buffer maintaining. Furthermore, the computation complexity of heap-based SpGEMM stays high with a higher compression ratio. The computation complexity (Cₕₑₐₚ) and memory costs (Mₕₑₐₚ) of heap-based SpGEMM are given as follows, where i=1˜M refers to the M rows of matrix A:

$${C}_{heap} = {\sum }_{i = 1}^{M} flop ( {c}_{i *} ) * ⌈ log ( nnz ( {a}_{i *} ) ⌉ \\ {M}_{heap} = {\sum }_{i = 1}^{M} nnz ( {c}_{i *} )$$

Hash-based SpGEMM uses a hash data structure of length flop(c_{i*}) to insert each partial result into the hash table with O(1) time complexity. Then it scans the hash table to extract the valid non-zero elements and sorts the result row in ascending order. Hash-based SpGEMM suffers from an inefficient cache access pattern. The inefficiency comes from huge cache capacity pressure and its random cache access pattern during hash table insertion. To compute each row, a hash table of size flop(c_{i*}) should be initialized as −1. This should be the maximum capacity to access for each row. During hash table insertion, the hash table is uniformly and randomly accessed. This can lead to a waste of cache capacity (e.g., a user may only need to access 8 bytes for double-precision data but have to access the whole 64 bytes cache line). After the insertion to hash table, the whole hash table has to be scanned again and extract nnz(c_{i*}) non-zeros to another cached place for sorting. This will impose even larger cache capacity pressure (flop(c_{i*})+nnz(c_{i*})), which is much greater than heap-based and the memory-efficient accumulation with ping-pong buffers described above. The computation complexity (Cₕₐₛₕ) and memory costs (Mₕₐₛₕ) of hash-based SpGEMM are given as follows:

$${C}_{hash} = {\sum }_{i = 1}^{M} ( α * flop ( {c}_{i *} ) + nnz ( {c}_{i *} ) * ⌈ log ( nnz ( {c}_{i *} ) ) ⌉ ) \\ {M}_{hash} = {\sum }_{i = 1}^{M} ( {β}_{1} * ( flop ( {c}_{i *} ) + nnz ( {c}_{i *} ) ) + nnz ( {c}_{i *} ) )$$

where α is a factor that is slighter greater than one due to possible hash table conflict, β1 is a factor less than one since such operations are expected (but not guaranteed) to perform in the cache rather than in main memory.

Referring back to the method 500 of memory-efficient accumulation with ping-pong buffers, merging the iₜₕ row needs ┌log(nnz(a_{i*}))┐ rounds of merging. During the first round, the number of comparison operations is the same as the number of floating-point multiplication operations (flop(c_{i*})). In the following rounds, the number of comparisons decreases due to duplicated column indices. During the last round, the number of comparisons is equal to the number of non-zero elements in the result row (nnz(c_{i*})). As a result, a de-skewed computation complexity of method 500 may be given as:

$${C}_{pingpong} = {\sum }_{i = 1}^{M} ( \frac{flop ( {c}_{i *} ) + nnz ( {c}_{i *} )}{2} ⌈ log ( nnz ( {a}_{i *} ) ) ⌉ )$$

In terms of memory complexity, in the proposed ping-pong buffered row merging method, multiple rounds of merging operations only take place between the two ping-pong buffers. For each row, it only accesses at maximum flop(c_{i*}) memory space in the first multiply phase, and the required space get smaller as the multiple rounds of merging phase is performed. Since the required space (flop(c_{i*})) is usually smaller than L1/L2 cache, cache hit rates is very high during the most computation-intensive accumulation phase. Moreover, modern CPU architecture adopts write-back cache policy and LRU cache replacement policy. Thus, the frequent data access to the two ping-pong buffers may not commit main memory requests at all. Main memory accesses happen only when the final result row is copied from the cached ping-pong buffer to the intermediate matrix (e.g., stored in a system memory) in the last round. Also note that both the main memory access pattern and cache access pattern are the most efficient streaming pattern. As a result, the proposed method may achieve optimal cache reuse and fewest main memory access. The memory complexity of method 500 may be given as:

$${M}_{pingpong} = {\sum }_{i = 1}^{M} ( {β}_{2} * flop ( {c}_{i *} ) + nnz ( {c}_{i *} ) )$$

where β2 is a factor less than one since the corresponding operation are expected to perform in cache, and β2 is also less than β1 due to better cache efficiency (case reuse). The computation complexity of method 500 greatly outperforms that of the heap-based method with approximately the same memory overheads (memory complexity). Compared with the hash-based method, the proposed approach performs better in memory complexity with comparable computation complexity.

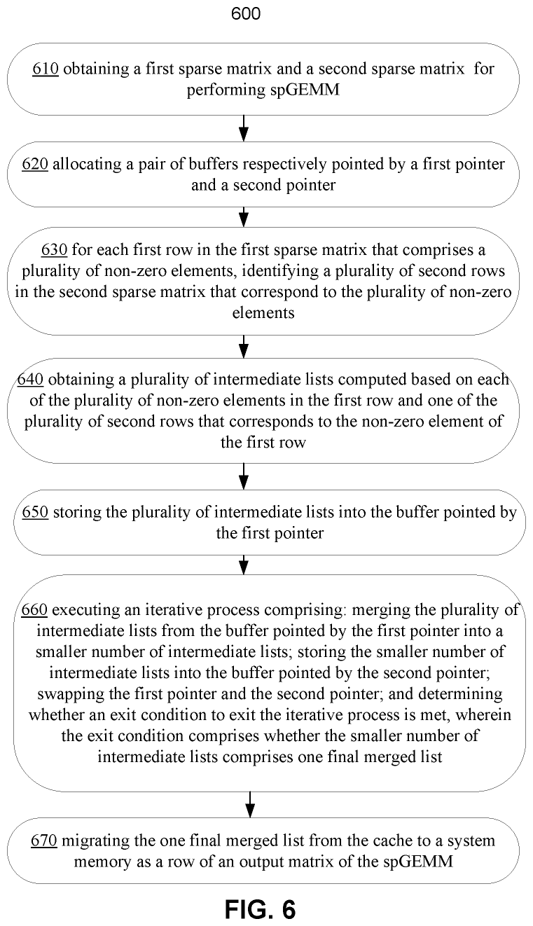

FIG. 6 illustrates an exemplary method 600 of memory-efficient accumulation for SpGEMM in accordance with some embodiments. The method 600 may be implemented in an environment shown in FIG. 1. The method 600 may be performed by a device, apparatus, or system illustrated by FIGS. 1-5, such as the processor 300 in FIG. 3. Depending on the implementation, the method 600 may include additional, fewer, or alternative steps performed in various orders or parallel.

Referring to the details of method 600, step 610 includes obtaining, by a processor associated with a cache, a first sparse matrix and a second sparse matrix for performing SpGEMM. In some embodiments, the first sparse matrix and the second sparse matrix are stored in a compact data format, wherein the compact data format excludes zero-value data in the first sparse matrix and the second sparse matrix.

Step 620 includes allocating, by the processor from the cache, a pair of buffers that are respectively pointed by a first pointer and a second pointer.

Step 630 includes for each first row in the first sparse matrix that comprises a plurality of non-zero elements, identifying, by the processor, a plurality of second rows in the second sparse matrix that correspond to the plurality of non-zero elements.

Step 640 includes obtaining, by the processor, a plurality of intermediate lists computed based on each of the plurality of non-zero elements in the first row and one of the plurality of second rows that corresponds to the non-zero element.

Step 650 includes storing, by the processor, the plurality of intermediate lists into the buffer pointed by the first pointer.

Step 660 includes executing, by the processor, an iterative process comprising: merging the plurality of intermediate lists from the buffer pointed by the first pointer into a smaller number of intermediate lists; storing the smaller number of intermediate lists into the buffer pointed by the second pointer; swapping the first pointer and the second pointer; and determining whether an exit condition to exit the iterative process is met, wherein the exit condition comprises whether the smaller number of intermediate lists comprises one final merged list. In some embodiments, the merging the plurality of intermediate lists from the buffer pointed by the first pointer into the smaller number of intermediate lists and storing the smaller number of intermediate lists into the buffer pointed by the second pointer comprises: for two adjacent intermediate lists of the plurality of intermediate lists: (1) determining two memory offsets in the buffer pointed by the first pointer, the two memory offsets pointing to the two intermediate lists respectively; (2) determining a destination memory offset in the buffer pointed by the second pointer; (3) retrieving, at the memory offsets of the buffer pointed by the first pointer, column indices of two elements; (4) in response to the column indices of the two elements being same, aggregating values of the two unmerged elements to obtain an aggregated value, storing the aggregated value into a merged list starting at the destination memory offset in the buffer pointed by the second pointer; (5) in response to the column indices of the two elements being different, storing one of the two unmerged elements that comprises a smaller value into the merged list starting at the destination memory offset in the buffer pointed by the second pointer; and repeating steps (1)-(5) until the two intermediate lists are merged into the merged list in the buffer pointed by the second pointer.

Step 670 includes migrating, by the processor, the one final merged list from the cache to a system memory as a row of an output matrix of the SpGEMM.

In some embodiments, the method 600 may further include allocating an offset buffer comprising a plurality of offsets respectively corresponding to the plurality of intermediate lists, wherein each offset points to a first unmerged element in the corresponding intermediate list. In some embodiments, in response to merging the plurality of intermediate lists into the smaller number of intermediate lists, the offset buffer may be updated so that each index points to an offset of a first unmerged element in one of the smaller number of intermediate lists. In some embodiments, the offset buffer comprises a pair of index lists respectively corresponding to the pair of buffers. In some embodiments, the method 600 may further include determining a buffer size for the offset buffer based on a maximum number of non-zero data in each row of the first sparse matrix.

In some embodiments, the method 600 may further include determining a buffer size for the pair of buffers by performing a symbolic computation based on indices of non-zero elements in the first sparse matrix and row sizes of the second sparse matrix, wherein the symbolic computation estimates a maximum number of floating-point multiplication operations (FLOP) in a hypothetical multiplication between each of the plurality of first rows and the second sparse matrix, wherein the allocating the pair of buffers comprises: allocating each of the pair of buffers with the buffer size. In some embodiments, the symbolic computation comprises: for each of the plurality of first rows that comprises one or more non-zero elements, identifying one or more corresponding second rows from the second sparse matrix; determining a number of FLOP for the each first row based on a number of non-zero elements in the one or more corresponding second rows from the second sparse matrix; and determining the maximum number of FLOP of the plurality of first rows as the buffer size.

In some embodiments, the processor includes a multi-core processor, and the method 600 may further includes: segmenting rows of the first sparse matrix into multiple groups of first rows according to a number of cores in the multi-core processor; and assigning the multiple groups of first rows into the number of cores for parallel processing, wherein each core allocates a corresponding pair of buffers. The multi-core processor may be a multi-core CPU, or a GPU, and the number of cores being a plurality of Streaming Multiprocessors (SMs) of the GPU.

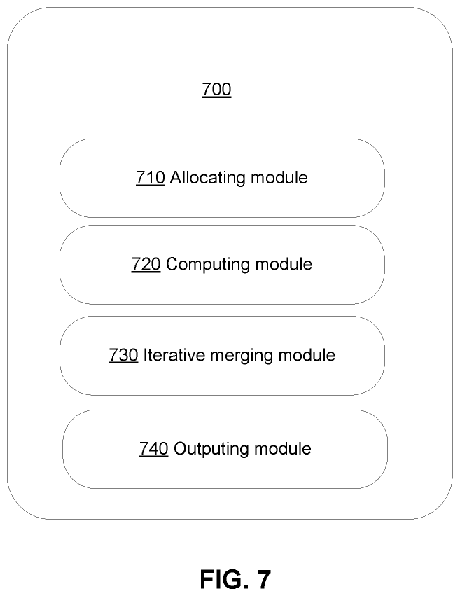

FIG. 7 illustrates a block diagram of a hardware device 700 with memory-efficient accumulation for SpGEMM in accordance with some embodiments. The components of the hardware device 700 presented below are intended to be illustrative. Depending on the implementation, the hardware device 700 may include additional, fewer, or alternative components.

The hardware device 700 may be an example of implementing the method 600 of FIG. 6. The hardware device 700 may include one or more processors and one or more non-transitory computer-readable storage media (e.g., one or more memories) coupled to the one or more processors and configured with instructions executable by the one or more processors to cause the system or device (e.g., the processor) to perform the above-described embodiments. The hardware device 700 may include various units/modules corresponding to the instructions (e.g., software instructions). The hardware device 700 may be implemented as the GNN accelerator

In some embodiments, the hardware device 700 may include an allocating module 710, a computing module 720, an iterative merging module 730, and an outputting module 740. These units may be implemented by the hardware devices and electronic circuits illustrated in FIGS. 1-5.

In some embodiments, the allocating module 710 may be configured to determine an upper bound of a memory size for merging a plurality of intermediate products of a SpGEMM, and allocate a pair of buffers based on the determined upper bound memory size. The pair of buffers may be respectively pointed by a first pointer and a second pointer. In some embodiments, the upper bound of the memory size may be determined by performing a symbolic computation based on indices of non-zero elements in the first sparse matrix and row sizes of the second sparse matrix, wherein the symbolic computation estimates a maximum number of floating-point multiplication operations (FLOP) in a hypothetical multiplication between each of the plurality of first rows and the second sparse matrix.

In some embodiments, the computing module 720 may be configured to, for each first row in the first sparse matrix that comprises a plurality of non-zero elements, identify a plurality of second rows in the second sparse matrix that correspond to the plurality of non-zero elements, and obtain a plurality of intermediate lists computed based on each of the plurality of non-zero elements in the first row and one of the plurality of second rows that corresponds to the non-zero element.

In some embodiments, the iterative in-memory merging module 730 may be configured to store the plurality of intermediate lists into the buffer pointed by the first pointer; execute an iterative process including: merge the plurality of intermediate lists from the buffer pointed by the first pointer into a smaller number of intermediate lists; store the smaller number of intermediate lists into the buffer pointed by the second pointer; swap the first pointer and the second pointer; and determine whether an exit condition to exit the iterative process is met, wherein the exit condition comprises whether the smaller number of intermediate lists comprises one final merged list.

In some embodiments, the outputting module 740 may be configured to migrate the one final merged list to a system memory as a row of an output matrix of the SpGEMM.

Each process, method, and algorithm described in the preceding sections may be embodied in, and fully or partially automated by, code modules executed by one or more computer systems or computer processors comprising computer hardware. The processes and algorithms may be implemented partially or wholly in application-specific circuit.

When the functions disclosed herein are implemented in the form of software functional units and sold or used as independent products, they can be stored in a processor executable non-volatile computer-readable storage medium. Particular technical solutions disclosed herein (in whole or in part) or aspects that contribute to current technologies may be embodied in the form of a software product. The software product may be stored in a storage medium, comprising a number of instructions to cause a computing device (which may be a personal computer, a server, a network device, and the like) to execute all or some steps of the methods of the embodiments of the present application. The storage medium may comprise a flash drive, a portable hard drive, ROM, RAM, a magnetic disk, an optical disc, another medium operable to store program code, or any combination thereof.

Particular embodiments further provide a system comprising a processor and a non-transitory computer-readable storage medium storing instructions executable by the processor to cause the system to perform operations corresponding to steps in any method of the embodiments disclosed above. Particular embodiments further provide a non-transitory computer-readable storage medium configured with instructions executable by one or more processors to cause the one or more processors to perform operations corresponding to steps in any method of the embodiments disclosed above.

Embodiments disclosed herein may be implemented through a cloud platform, a server or a server group (hereinafter collectively the “service system”) that interacts with a client. The client may be a terminal device, or a client registered by a user at a platform, where the terminal device may be a mobile terminal, a personal computer (PC), and any device that may be installed with a platform application program.

The various features and processes described above may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The exemplary systems and components described herein may be configured differently than described. For example, elements may be added to, removed from, or rearranged compared to the disclosed example embodiments.

The various operations of example methods described herein may be performed, at least partially, by an algorithm. The algorithm may be comprised in program codes or instructions stored in a memory (e.g., a non-transitory computer-readable storage medium described above). Such algorithm may comprise a machine learning algorithm. In some embodiments, a machine learning algorithm may not explicitly program computers to perform a function but can learn from training data to make a prediction model that performs the function.

The various operations of example methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Any process descriptions, elements, or blocks in the flow diagrams described herein and/or depicted in the attached figures should be understood as potentially representing modules, segments, or sections of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

As used herein, “or” is inclusive and not exclusive, unless expressly indicated otherwise or indicated otherwise by context. Therefore, herein, “A, B, or C” means “A, B, A and B, A and C, B and C, or A, B, and C,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The term “include” or “comprise” is used to indicate the existence of the subsequently declared features, but it does not exclude the addition of other features. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

What is claimed is:

1. A computer-implemented method for memory-efficient accumulation in executing sparse matrix-matrix multiplications (SpGEMM), comprising:
obtaining, by a processor associated with a memory, a first sparse matrix and a second sparse matrix for performing SpGEMM;
allocating, by the processor from the memory, a pair of buffers that are respectively pointed by a first pointer and a second pointer;
for each first row in the first sparse matrix that comprises a plurality of non-zero elements, identifying, by the processor, a plurality of second rows in the second sparse matrix that correspond to the plurality of non-zero elements;
obtaining, by the processor, a plurality of intermediate lists computed based on each of the plurality of non-zero elements in the first row and one of the plurality of second rows that corresponds to the non-zero element of the first row;
storing, by the processor, the plurality of intermediate lists into the buffer pointed by the first pointer;
executing, by the processor, an iterative process comprising:
merging the plurality of intermediate lists from the buffer pointed by the first pointer into a smaller number of intermediate lists;
storing the smaller number of intermediate lists into the buffer pointed by the second pointer;
swapping the first pointer and the second pointer; and
determining whether an exit condition to exit the iterative process is met, wherein the exit condition comprises whether the smaller number of intermediate lists comprises one final merged list; and
migrating, by the processor, the one final merged list from the buffer pointed by the first pointer to a system memory as a row of an output matrix of the SpGEMM.

2. The method of claim 1, further comprising:
allocating an offset buffer comprising a plurality of offsets respectively corresponding to the plurality of intermediate lists, wherein each offset points to a first unmerged element in the corresponding intermediate list.

3. The method of claim 2, further comprising:
in response to merging the plurality of intermediate lists into the smaller number of intermediate lists, updating the offset buffer so that each offset points to an offset of a first unmerged element in one of the smaller number of intermediate lists.

4. The method of claim 1, wherein the merging the plurality of intermediate lists from the buffer pointed by the first pointer into the smaller number of intermediate lists and storing the smaller number of intermediate lists into the buffer pointed by the second pointer comprises:
for two adjacent intermediate lists of the plurality of intermediate lists:
(1) determining two memory offsets in the buffer pointed by the first pointer, the two memory offsets pointing to the two intermediate lists respectively;
(2) determining a destination memory offset in the buffer pointed by the second pointer;
(3) retrieving, at the memory offsets of the buffer pointed by the first pointer, column indices of two elements;
(4) in response to the column indices of the two elements being same, aggregating values of the two unmerged elements to obtain an aggregated value, storing the aggregated value into a merged list starting at the destination memory offset in the buffer pointed by the second pointer;
(5) in response to the column indices of the two elements being different, storing one of the two unmerged elements that comprises a smaller value into the merged list starting at the destination memory offset in the buffer pointed by the second pointer; and
repeating steps (1)-(5) until the two intermediate lists are merged into the merged list in the buffer pointed by the second pointer.

5. The method of claim 1, wherein the first sparse matrix and the second sparse matrix are stored in a compact data format, wherein the compact data format excludes zero-value data in the first sparse matrix and the second sparse matrix.

6. The method of claim 1, further comprising:
determining a buffer size for the pair of buffers by performing a symbolic computation based on indices of non-zero elements in the first sparse matrix and row sizes of the second sparse matrix, wherein the symbolic computation estimates a maximum number of floating-point multiplication operations (FLOP) in a hypothetical multiplication between each of the plurality of first rows and the second sparse matrix,
wherein the allocating the pair of buffers comprises:
allocating each of the pair of buffers with the buffer size.

7. The method of claim 6, wherein the symbolic computation comprises:
for each of the plurality of first rows that comprises one or more non-zero elements, identifying one or more corresponding second rows from the second sparse matrix;
determining a number of FLOP for the each first row based on a number of non-zero elements in the one or more corresponding second rows from the second sparse matrix; and
determining the maximum number of FLOP of the plurality of first rows as the buffer size.

8. The method of claim 1, wherein the processor comprises a multi-core processor, and the method further comprises:
segmenting rows of the first sparse matrix into multiple groups of first rows according to a number of cores in the multi-core processor; and
assigning the multiple groups of first rows into the number of cores for parallel processing, wherein each core allocates a corresponding pair of buffers.

9. The method of claim 8, wherein the multi-core processor comprises a multi-core CPU.

10. The method of claim 8, wherein the multi-core processor comprises a GPU, and the number of cores comprise a plurality of Streaming Multiprocessors (SMs) of the GPU.

11. The method of claim 2, wherein the offset buffer comprises a pair of index lists respectively corresponding to the pair of buffers.

12. The method of claim 2, further comprising:
determining a buffer size for the offset buffer based on a maximum number of non-zero data in each row of the first sparse matrix.

13. A system for memory-efficient accumulation to accelerate SpGEMM computations, comprising one or more processors and one or more non-transitory computer-readable memories coupled to the one or more processors and configured with instructions executable by the one or more processors to cause the system to perform operations comprising:
obtaining a first sparse matrix and a second sparse matrix for performing SpGEMM;
allocating a pair of buffers in a cache associated with the one or more processors, the pair of buffers respectively pointed by a first pointer and a second pointer;
for each first row in the first sparse matrix that comprises a plurality of non-zero elements, identifying a plurality of second rows in the second sparse matrix that correspond to the plurality of non-zero elements;
obtaining a plurality of intermediate lists computed based on each of the plurality of non-zero elements in the first row and one of the plurality of second rows that corresponds to the non-zero element;
storing the plurality of intermediate lists into the buffer pointed by the first pointer;
executing an iterative process comprising:
merging the plurality of intermediate lists from the buffer pointed by the first pointer into a smaller number of intermediate lists;
storing the smaller number of intermediate lists into the buffer pointed by the second pointer;
swapping the first pointer and the second pointer; and
determining whether an exit condition to exit the iterative process is met, wherein the exit condition comprises whether the smaller number of intermediate lists comprises one final merged list; and
migrating the one final merged list from the cache to the one or more non-transitory memories as a row of an output matrix of the SpGEMM.

14. The system of claim 13, wherein the operations further comprise:
determining a buffer size for the pair of buffers by performing a symbolic computation based on indices of non-zero elements in the first sparse matrix and row sizes of the second sparse matrix, wherein the symbolic computation estimates a maximum number of floating-point multiplication operations (FLOP) in a hypothetical multiplication between each of the plurality of first rows and the second sparse matrix,
wherein the allocating the pair of buffers comprises:
allocating each of the pair of buffers with the buffer size.

15. The system of claim 14, wherein the symbolic computation comprises:
for each of the plurality of first rows that comprises one or more non-zero elements, identifying one or more corresponding second rows from the second sparse matrix;
determining a number of FLOP for the each first row based on a number of non-zero elements in the one or more corresponding second rows from the second sparse matrix; and
determining the maximum FLOP of the plurality of first rows as the buffer size.

16. The system of claim 13, wherein the operations further comprise:
allocating an offset buffer comprising a plurality of offsets respectively corresponding to the plurality of intermediate lists, wherein each offset points to a first unmerged element in the corresponding intermediate list.

17. The system of claim 13, wherein the merging the plurality of intermediate lists from the buffer pointed by the first pointer into the smaller number of intermediate lists and storing the smaller number of intermediate lists into the buffer pointed by the second pointer comprises: —FIG. 1
for two adjacent intermediate lists of the plurality of intermediate lists:
(1) determining two memory offsets in the buffer pointed by the first pointer, the two memory offsets pointing to the two intermediate lists respectively;
(2) determining a destination memory offset in the buffer pointed by the second pointer;
(3) retrieving, at the memory offsets of the buffer pointed by the first pointer, column indices of two elements;
(4) in response to the column indices of the two elements being same, aggregating values of the two unmerged elements to obtain an aggregated value, storing the aggregated value into a merged list starting at the destination memory offset in the buffer pointed by the second pointer;
(5) in response to the column indices of the two elements being different, storing one of the two unmerged elements that comprises a smaller value into the merged list starting at the destination memory offset in the buffer pointed by the second pointer; and
repeating steps (1)-(5) until the two intermediate lists are merged into the merged list in the buffer pointed by the second pointer.

18. A non-transitory computer-readable storage medium for memory-efficient accumulation to accelerate SpGEMM computations between a first sparse matrix and a second sparse matrix, the storage medium storing instructions that, when executed by one or more processors, cause the one or more processors to perform operations comprising:
obtaining a first sparse matrix and a second sparse matrix for performing SpGEMM;
allocating a pair of buffers in a cache associated with the one or more processors, the pair of buffers respectively pointed by a first pointer and a second pointer;
for each first row in the first sparse matrix that comprises a plurality of non-zero elements, identifying a plurality of second rows in the second sparse matrix that correspond to the plurality of non-zero elements;
obtaining a plurality of intermediate lists computed based on each of the plurality of non-zero elements in the first row and one of the plurality of second rows that corresponds to the non-zero element;
storing the plurality of intermediate lists into the buffer pointed by the first pointer;
executing an iterative process comprising:
merging the plurality of intermediate lists from the buffer pointed by the first pointer into a smaller number of intermediate lists;
storing the smaller number of intermediate lists into the buffer pointed by the second pointer;
swapping the first pointer and the second pointer; and
determining whether an exit condition to exit the iterative process is met, wherein the exit condition comprises whether the smaller number of intermediate lists comprises one final merged list; and
migrating the one final merged list to the one or more non-transitory memories as a row of an output matrix of the SpGEMM.

19. The non-transitory computer-readable storage medium of claim 18, wherein the operations further comprise:
determining a buffer size for the pair of buffers by performing a symbolic computation based on indices of non-zero elements in the first sparse matrix and row sizes of the second sparse matrix, wherein the symbolic computation estimates a maximum number of floating-point multiplication operations (FLOP) in a hypothetical multiplication between each of the plurality of first rows and the second sparse matrix,
wherein the allocating the pair of buffers comprises:
allocating each of the pair of buffers with the buffer size.

20. The non-transitory computer-readable storage medium of claim 19, wherein the symbolic computation comprises:
for each of the plurality of first rows that comprises one or more non-zero elements, identifying one or more corresponding second rows from the second sparse matrix;
determining a number of FLOP for the each first row based on a number of non-zero elements in the one or more corresponding second rows from the second sparse matrix; and
determining the maximum FLOP of the plurality of first rows as the buffer size.
